(19) United States
(12) Patent Application Publication
(10) Pub. No.: US 2002/0047642 A1
(43) Pub. Date: Apr. 25, 2002

(54) Light emitting device and drive IC of portable telephone

(75) Inventor: Shozo Miyagawa, Kyoto-shi (JP)

Correspondence Address: SUGHRUE, MION, ZINN, MACPEAK & SEAS, PLLC, 2100 Pennsylvania Avenue, N.W., Washington, DC, 20037-3213, US

(73) Assignee: ROHM CO., LTD.

(21) Appl. No.: 09/968,775

(22) Filed: Oct. 3, 2001

(30) Foreign Application Priority Data
Oct. 3, 2000 (JP) 2000-303100

(51) Int. Cl. G05F 1/00

(52) U.S. Cl. 315/307; 315/247

(57) ABSTRACT

The invention provides a light emitting device of a portable telephone, for stabilizing the brightness and color tone of the display, which operates by a power of a battery together with a communication circuit, includes plural light emitting elements of which light emission colors are different, which are driven individually by a pulse width modulation method. It also includes a voltage boosting circuit having a smoothing circuit connected to an output side thereof, whose output is supplied to the light emitting elements. Thus, by raising and stabilizing the battery voltage and supplying it to the light emitting elements, the light emitting elements are driven with a margin, and they are also blocked from an influence of the fluctuations of the battery voltage.

### BACKGROUND OF THE INVENTION

1. Field of the Invention

The present invention relates to a light emitting device of a portable telephone, specifically to a light emitting device that enables a selective setting of the back lighting colors, etc., by driving plural elements that emit light in different colors.

Here, the portable telephone in this specification corresponds to an analog or a digital portable telephone, a PHS (Personal Handy-phone System), and a receiver as an extension used for a radio communication with a fixed type telephone as the parent apparatus.

2. Related Art

The structural outline illustrated in FIG. 7 is a back light display device of a conventional portable telephone that is disclosed in the Japanese Published Unexamined Patent Application No. H11-266295. This device is furnished with plural pulse width modulator (PWM) circuits which change the pulse width in a controlling means, plural LED drive transistors that receive the pulses outputted from the plural pulse width modulator circuits, and plural light emitting diodes (LED) that emit lights in different colors, such as blue, green, or red, which are driven by the outputs of the plural LED driving transistors. And, adjusting the pulse width outputted from each pulse width modulator circuit according to the setting inputted by a key operation, etc., brings about changes in the luminous intensity of each light emitting diode, thus enabling a user to set the back light display color to any color that the user prefers.

Although not disclosed in the publication, in general, the portable telephone is equipped with a communication circuit and an antenna for radio communication, and in addition to this, it is usually equipped with a rechargeable battery that is detachable. And, the power supplied from the battery operates not only the communication circuit, but also the back light display device.

However, in general, the power supply used for the portable telephone is a lithium ion battery, and the output voltage of the battery is about 3.6V. As for the forward voltage (forward voltage drop) of the blue or the green light emitting diode is about 4V, which is higher than the output voltage of the battery. Therefore, to supply the output voltage as it is will not turn on the blue or the green light emitting diode having a higher forward voltage, which is different from the red light emitting diode having a lower forward voltage. Accordingly, to reconstruct the circuit for the light emitting device of the portable telephone so as to turn on all the light emitting diodes with the power of the battery is the fundamental problem.

On the other hand, since the portable telephones, such as PDC (Personal Digital Cordless telephone), GSM (Global System for Mobile communications), and PHS, etc., adopt the time division multiple access (TDMA), the transmissions and receptions are carried out in burst conditions (suddenly and intermittently). Therefore, the current supplied to the communication circuit from the battery varies in the burst conditions. And, in accordance with this varies the voltage drop caused by the internal resistance of the battery, etc., and also the output voltage of the battery varies accordingly. And, as the applied voltage to the light emitting diode varies affected by this variation, the brightness changes undesirably, causing inconveniences, such as flickering of the lighting and display. Also, when the degree of influence given to the light emitting diodes of different emitting colors differs, even the color tones change undesirably. Accordingly, to improve so as to relieve or resolve such influence will be another problem.

### SUMMARY OF THE INVENTION

The present invention has been made in view of the above circumstances, and an object of the invention is to provide a light emitting device of a portable telephone with stable brightness and color tone.

With regard to the first through the third measures to accomplish the object of the invention, the constructions and the functional effects of the measures will hereby be described.

First Measure

The light emitting device of the portable telephone as the first measure, as disclosed in claim 1 at the beginning of the application, operates by a power of a battery together along with a communication circuit. The light emitting device includes plural light emitting elements of which light emission colors are different, which are driven individually by a pulse width modulation method. It also includes a voltage boosting circuit having a smoothing circuit connected to an output side thereof, whose output is supplied to the light emitting elements.

Here, a preferable drive IC for implementing this kind of light emitting device, as disclosed in claim 4 at the beginning of the application, includes: a voltage boosting circuit having separate terminals connected to an input and output thereof; plural pulse width modulator circuits, wherein each modulation degree can be set separately; and plural drive circuits corresponding to the plural pulse width modulator circuits, wherein a drive state to each connecting terminal is switched in response to an output pulse from a corresponding one of the pulse width modulator circuits. And, connecting the smoothing circuit and the light emitting elements to the terminals of this drive IC will form the light emitting device of the portable telephone as the first measure.

In the light emitting device of the portable telephone as the first measure, the brightness and the color tone, etc. in the color display and lighting can freely be set by varying the degree of each pulse width modulation. Also, by the introduction of the voltage boosting circuit and the realization of its output being supplied to the light emitting elements, even if there are differences of the forward voltages among the light emitting elements of different luminous colors, a sufficient voltage can be applied to all the light emitting elements including the one requiring a higher forward voltage, and each of the light emitting elements can be driven with a margin, thus stabilizing the state of light emission, which is desirable. Further, in addition to the insertion of the voltage boosting circuit between the battery/communication circuit and the light emitting diodes, the smoothing circuit is connected on the side of the light emitting elements, the propagation of the battery voltage fluctuations caused by the operation state of the communication circuit to the light emitting elements can be blocked or restricted sufficiently, which still more stabilizes the driving state and light emission state of the light emitting elements.

Therefore, according to this invention, the light emitting device of the portable telephone can be implemented with stable brightness and color tone.

Second Measure

The light emitting device of the portable telephone as the second measure, as disclosed in claim 2 at the beginning of the application, is the light emitting device as the first measure, in which some of the light emitting elements are supplied with the output of the battery instead of the output of the voltage boosting circuit.

The aforementioned drive IC is also preferable for implementing this light emitting device.

In such a light emitting device of the portable telephone as the second measure, the output of the battery can be supplied directly to the light emitting element of a low forward voltage, without passing through the voltage boosting circuit. Therefore, the voltage boosting circuit is only needed to drive the light emitting elements of a higher forward voltage.

This measure makes it possible to reduce the scale of the voltage boosting circuit, which is likely to become large. And, even with this configuration, all the light emitting elements will be driven with a margin, and the state of light emission becomes stable and desirable.

Therefore, according to this invention, the light emitting device of the portable telephone with stable brightness and color tone can be realized with a circuit of a smaller scale.

Third Measure

The light emitting device of the portable telephone as the third measure, as disclosed in claim 3 at the beginning of the application, being the light emitting device of the portable telephone as the second measure, further includes an automatic control means that increases and decreases a degree of the pulse width modulation to a part of the light emitting elements (namely, the light emitting elements to which the output of the battery is supplied instead of the output from the voltage boosting circuit) in accordance with the output voltage of the battery.

Also, a preferable drive IC for implementing this kind of light emitting device, as disclosed in claim 5 at the beginning of the application, is the drive IC used for the light emitting device as the first measure, and it includes an automatic control means that increases and decreases a degree of the pulse width modulation of a part of the pulse width modulator circuits in accordance with an input voltage to the voltage boosting circuit. And, connecting the smoothing circuit and the light emitting elements to the terminals of this drive IC will form the light emitting device of the portable telephone as the third measure.

In such a light emitting device of the portable telephone as the third measure, in regard to the light emitting elements to which a battery voltage including the fluctuations is applied as it is, the degree of the pulse width modulation is increased or decreased in accordance with the output voltage of the battery by the automatic control means. In other words, as the battery voltage rises, the pulse width corresponding to the pulse signal is narrowed, which causes light emission among the pulse signals that control light emission and non-light emission; and as the battery voltage drops, the pulse width corresponding to the light emission signal is widened.

Thus, the light emitting elements that cannot be influenced by the ease of the fluctuations in the voltage boosting circuit are compensated by the automatic control means, which still more stabilizes the state of light emission of all the light emitting elements. Besides, this automatic control function is attained by means of the pulse width modulation method, which can be implemented with a simple and small-scale circuit.

Therefore, according to this invention, a light emitting device of the portable telephone with even more stable brightness and color tone can be implemented with a circuit of a smaller scale.

### BRIEF DESCRIPTION OF THE DRAWINGS

Preferred embodiments of the present invention will be described in detail based on the followings, wherein:

FIG. 1 is an overall schematic circuit diagram of the light emitting device of the portable telephone relating to the first embodiment of the invention;

FIG. 2 is a circuit diagram of a DC/DC converter relating to the first embodiment;

FIG. 3 is a chart illustrating the signal waveform of the pulse width modulator circuit relating to the first embodiment;

FIG. 4 is a detailed overall circuit diagram relating to the first embodiment;

FIG. 5 is an overall schematic circuit diagram of the light emitting device of the portable telephone relating to the second embodiment of the invention;

FIG. 6 is an overall schematic circuit diagram of the light emitting device of the portable telephone relating to the third embodiment of the invention; and,

FIG. 7 is a schematic illustration of a conventional backlight display device of the portable telephone.

### DETAILED DESCRIPTION OF THE INVENTION

A concrete configuration for implementing the light emitting device of the portable telephone accomplished by the above measures will be explained in the first through third embodiments.

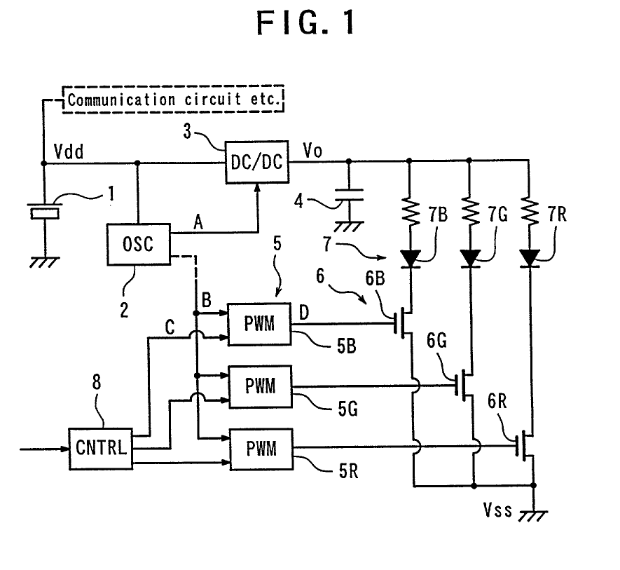

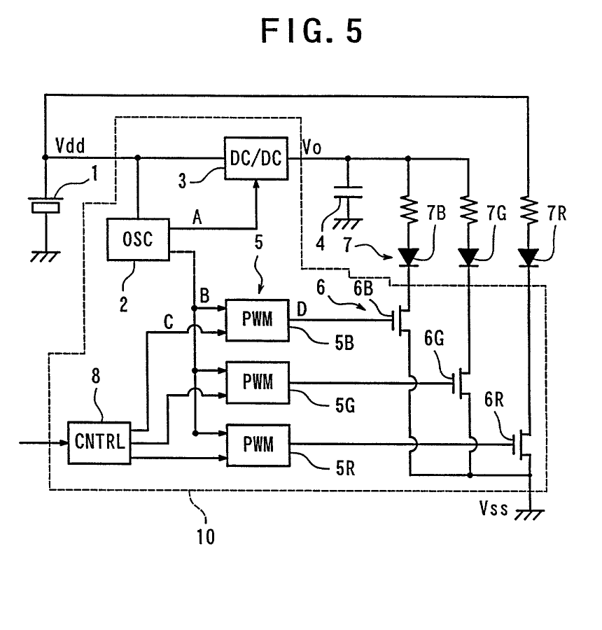

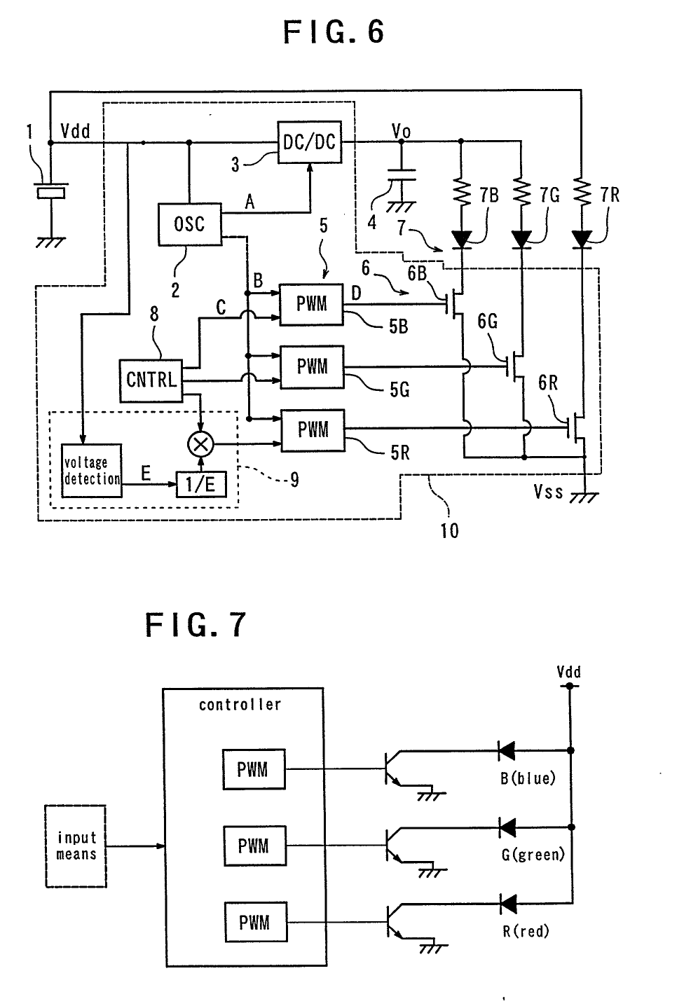

The first embodiment illustrated in FIG. 1 through FIG. 4 is the implementation of the first measure. The second embodiment illustrated in FIG. 5 is the implementation of the second measure. The third embodiment illustrated in FIG. 6 is the implementation of the third measure.

First Embodiment

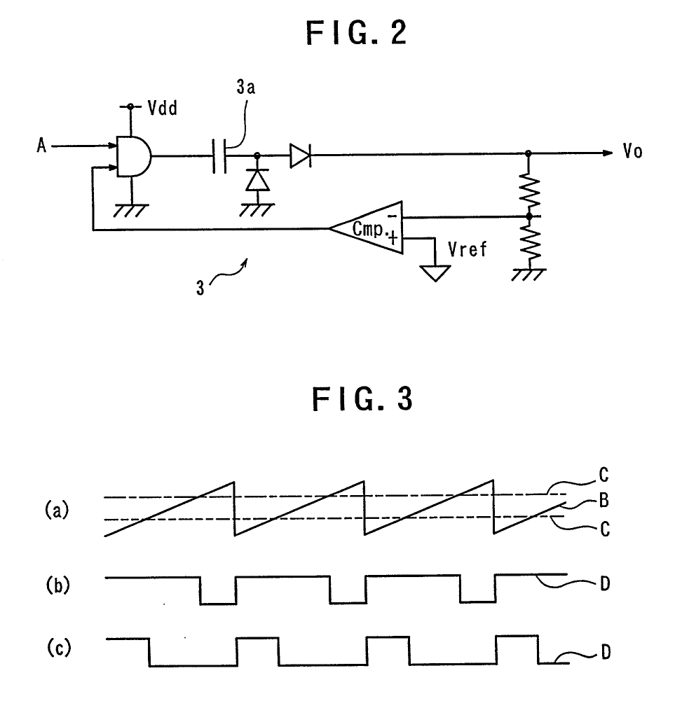

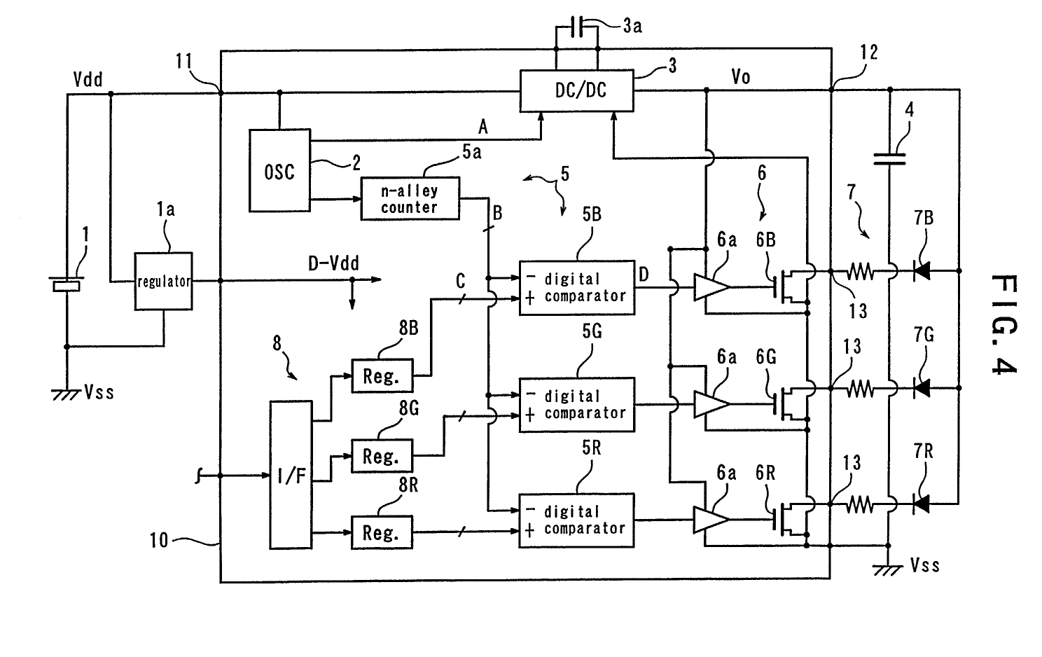

The concrete configuration of the light emitting device of the portable telephone relating to the first embodiment will be explained with reference to the drawings. FIG. 1 illustrates an overall schematic circuit of the light emitting device, FIG. 2 a circuit of the DC/DC converter, FIG. 3 a chart of the signal waveforms to explain the function of the pulse width modulator circuit, and FIG. 4 an overall circuit that is more detailed than FIG. 1.

This portable telephone (refer to FIG. 1) is provided with a battery 1 such as a lithium ion battery to be rechargeable or detachable, in order to ensure the operation in a mobile environment. And, it is also equipped with communication circuits and antenna, etc., not illustrated, in order to enable the radio communications. Further, it is furnished with input means such as keys and switches, etc., not illustrated, in order to allow the dialing operation and the other input operations. In any case, it is configured to operate, or become operable by the power supply from battery 1.

Also, a colored light emitting device is installed on a display unit such as an LCD, on the lighting and incoming indication of the keyboard. This light emitting device is also operated by the power supply from the battery 1, and its light emission unit 7 (refer to FIG. 1) is furnished with three types of light-emitting diodes (light emitting elements) with different emitting colors, in order to realize the light emission in an arbitrary color by mixed colors. To be concrete, the light emission unit 7 includes a light emitting diode 7B that emits light in blue, a light emitting diode 7G that emits light in green, and a light emitting diode 7R that emits light in red, and these diodes each are connected in series with current limiting resistors for protecting the diodes if necessary.

Further, this light emitting device is provided with a voltage boosting circuit 2+3, including an oscillator 2 and a DC/DC converter 3, by which the output voltage Vdd of battery 1 is boosted to a voltage Vo. And at the same time, the wiring connection is made so that this high voltage Vo can be applied to each of the anodes of the light emitting diodes 7B, 7G, and 7R of the light emission unit 7. Also, along the line of the voltage Vo from the DC/DC converter 3 to the light emission unit 7, namely on the output side of the DC/DC converter 3, a capacitor 4 (smoothing circuit) is connected in order to restrain the ripples or the fluctuations of the voltage Vo by letting the high frequency components escape to the reference voltage Vss such as the grounding potential. Here, though the illustration has been omitted, the voltage boosting circuit 2+3 is also made to stop its operation in order to save energy, at the standby mode in accordance with the control from the outside.

Also, in order to individually drive the three light emitting elements provided in the light emission unit 7 by the pulse width modulation method, a drive unit 6 is also provided with three output stage transistors 6B, 6G, and 6R; and at the same time, a pulse width modulation unit 5 is also furnished with three sets of PWM circuits 5B, 5G, and 5R. Concretely, the drain of the output stage transistor 6B is connected to the cathode of the light emitting diode 7B either directly or by way of a resistor, the source thereof is connected to the reference voltage Vss, and the gate thereof is controlled by pulse signal D outputted from the PWM circuit 5B. The same can be said for the connection between the PWM circuit 5G, the output stage transistor 6G, and the light emitting diode 7G, and for the connection between the PWM circuit 5R, the output stage transistor 6R, and the light emitting diode 7R.

The PWM circuit 5B inputs a saw-tooth wave signal B and a threshold C to generate the pulse signal D based on these inputs. The same can be said for the PWM circuits 5G and 5R.

And, a control unit 8 is to enable the setting of the threshold C. This control unit 8 holds indicated values inputted by way of the aforementioned input means separately by each of the PWM circuits, 5B, 5G, and 5R, and sends out the indicated values to each of the circuits.

Now, the configuration of each circuit will be discussed. The DC/DC converter 3 adopts a charge pump with diodes combined, for example (refer to FIG. 2). The circuit is driven by an oscillation signal A inputted from the oscillator 2 through a capacitor 3a, compares a voltage detected by a resistance type potential divider, for example, dividing the output voltage Vo with a specific reference voltage Vref. Based on the comparison result, when the voltage detected from the voltage Vo is lower than the reference voltage Vref, the circuit transmits the oscillation signal A to the capacitor 3a; and when the voltage detected is higher, the circuit does not transmit the signal A. Thereby, the voltage Vo is to maintain a specific voltage suitable for driving the light emitting diodes 7B, 7G, for example, about 4.8 Volts. An AND gate that controls the transmission of the signal A and the oscillator 2 that generates the oscillation signal A operate under the output voltage Vdd of the battery 1. Therefore, the voltage boosting circuit 2+3 raises the battery voltage Vdd of approximately 3.6V up to the voltage Vo.

The PWM circuit 5B, and so forth (refer to FIG. 3) make the pulse signal D High, when the threshold C is higher than the saw-tooth wave signal B, and make the pulse signal D Low, when the threshold C is lower than the saw-tooth wave signal B, thus generating the pulse signal D (refer to FIG. 3a). When the threshold C is higher, the High pulse width is widened to increase the duty ratio (refer to FIG. 3b), and when the threshold C is lower, the High pulse width is narrowed to decrease the duty ratio (refer to FIG. 3c). And, in order to implement this function with a digital circuit, the pulse width modulation unit 5 (refer to FIG. 4) is provided with an n-ary counter 5a that inputs the oscillation signal of the oscillator 2 to increment the count value, for example, a 128-ary counter of 7 bits as a common unit. The individual PWM circuits 5B, 5G and 5R that input the count value as a digital saw-tooth wave signal B are all configured with digital comparators and so forth.

Since the threshold C is also a digital value, the control unit 8 (refer to FIG. 4) is provided with a register 8B that holds the threshold C of the PWM circuit 5B, a register 8G that holds the threshold C of the PWM circuit 5G, and a register 8R that holds the threshold C of the PWM circuit 5R. All of these registers are set with the threshold values by way of an interface (I/F).

And, in such a manner that these digital circuits can operate stably without the influence by the variations of the battery voltage Vdd, a regulator 1a, for example, drops the voltage Vdd to a voltage D-Vdd for a digital circuit and stabilizes it; and the voltage D-Vdd is supplied to the control unit 8 or the pulse width modulation unit 5.

Further, in drive unit 6 (refer to FIG. 4), in order to secure the on-off operation of the output stage transistors 6B, 6G, and 6R that drive the light emission unit 7 having the voltage Vo applied thereto, a level conversion circuit 6a that operates under the voltage Vo is inserted between each gate of the output stage transistors and the corresponding PWM circuit that controls it. And, the pulse signal D generated at the voltage level D-Vdd is used for driving the output stage transistors, after the voltage comes to the voltage level Vo.

This type of light emitting device is usually integrated into one chip IC 10 in order to answer the request for miniaturization when it is mounted on the portable telephone, except for the light emission unit 7, etc., being difficult to integrate. That is, this drive IC 10 includes the oscillator 2, the DC/DC converter 3 excluding the capacitor 3a, the drive unit 6, the pulse width modulation unit 5, and the control unit 8. And, inside the IC, the input line of the voltage boosting circuit 2+3 is connected to a terminal 11 for the connection with the battery 1, and the output line of the voltage boosting circuit 2+3 is connected to a terminal 12 for the connection with the smoothing capacitor 4 and the light emission unit 7. Each drains of the output stage transistors 6B, 6G, and 6R are connected to each terminals 13 for the connection with each drive objects, namely, the light emitting diodes 7B, 7G, and 7R. The terminals 11 through 13 are all for the connections with the outside units, and they may be metallic pins, leads, bonding pads, bumps of gold or solder, or aluminum electrodes, in correspondence with the package type of the IC 10.

Now, the mode of use and the operation will be explained in relation to the light emitting device of the portable telephone of the first embodiment.

When the voltage Vdd is supplied from the battery 1 and the standby mode is released, the oscillation signal A of the pulse voltage Vdd is transmitted to the DC/DC converter 3 from the oscillator 2, and the charge pump is switched by driving the DC/DC converter 3; thus, the voltage Vdd derives the voltage Vo higher than itself. And, the voltage Vo is smoothed by the capacitor 4, and the current of the voltage Vo is supplied to the light emission unit 7 and the drive unit 6. Also, receiving the oscillation from the oscillator 2, the counter 5a of the pulse width modulation unit 5 generates the saw-tooth wave signal B, which is transmitted to the PWM circuits 5B, 5G, and 5R.

On the other hand, the setting values inputted by way of the input means and so forth, namely, the thresholds C, etc., that determine each degrees of the pulse width modulations corresponding to the blue, green, and red light emissions are each retained by the registers 8B, 8G and 8R of the control unit 8, and are transmitted to the PWM circuits 5B, 5B and 5R. Here, the pulse signals D having the duty ratios corresponding to the thresholds C, etc., are generated in parallel, which are each supplied to drive the gates of the output stage transistors 6B, 6G and 6R by way of the level conversion circuits 6a. And, in accordance with these pulses, as the output stage transistors 6B, 6G and 6R are switched on and off with each pulse timings, the forward currents of the light emitting diodes 7B, 7G, and 7R of the light emitting unit 7 are switched on and off similarly with each corresponding pulse timings.

In this case, the light emitting diodes 7B, 7G, and 7R are supplied with the voltage Vo, which is smoothed and boosted higher than any of the forward voltages of these diodes. Therefore, if the output voltage Vdd of the battery 1 is somewhat low, moreover, if the voltage Vdd fluctuates in a burst state due to the communication conditions, etc., the light emitting diodes 7B, 7G, and 7R will accurately be switched on and off, and the states of the light emissions during the currents flowing through the diodes will be all stabilized to a constant. Therefore, the amounts of the light emissions are determined uniquely by the duty ratio of each corresponding pulse signal, namely the degree of the pulse width modulation.

As described above, this light emitting device of the portable telephone varies the luminous brightness of each light emitting diodes by appropriately setting the thresholds that determine the degrees of the pulse width modulations for the blue, green, and red light emissions respectively. Thus, it is possible to arbitrarily set the color of light emission so as to suit a user's taste. Moreover, since the luminous brightness of each light emitting diode is stabilized after the setting, during a call, or upon transmission or reception of a call, there will not be any inconveniences, such as darkening of the lighting and display, and changing of the color.

Second Embodiment

Now, a concrete configuration of the light emitting device of the portable telephone relating to the second embodiment will be explained with reference to the drawings. FIG. 5 is an overall schematic circuit diagram of the light emitting device relating to the second embodiment, which corresponds to FIG. 1 described above.

The difference of the light emitting device of the second embodiment from that of the first embodiment lies in that one of the light emitting elements 7B, 7G and 7R, namely the light emitting diode 7R is supplied with the output (Vdd) of the battery 1 instead of the output (Vo) of the voltage boosting circuit 2+3. Concretely, the branch line from the output (Vdd) of the battery 1, making a detour from the IC 10, extends to the light emitting diode 7R, and connects to the anode of the diode 7R directly or via a resistor.

In this case, the light emitting diodes 7B and 7G are applied with the voltage Vo, and the light emitting diode 7R is applied with the voltage Vdd, which is lower than the voltage Vo. Since the forward voltage of the light emitting diode 7R is lower than those of the light emitting diodes 7B and 7G, each of the light emitting diodes 7B, 7G and 7R is driven with a sufficient voltage that exceeds each forward voltage. And, even if the output voltage Vdd of the battery 1 fluctuates in response to the communication state, etc., as long as the forward voltage of the light emitting diode 7R is maintained, the brightness fluctuation of the light emitting diode 7R would be comparatively small. Since the difference between the average value of the voltage Vdd and the forward voltage of the light emitting diode 7R will ease the influence of the voltage fluctuation with a margin, the light emission state of the light emitting diode 7R is also stabilized in this case. The other light emitting diodes 7B and 7G will maintain stable light emissions under the boosted voltage Vo, as mentioned above.

Also, since it handles a higher power compared to the pulse width modulation unit 5 or the control unit 8, the voltage boosting circuit 2+3 tends to occupy a larger area in the layout of the IC 10 when integrated into the IC. In this case, however, the output of the DC/DC converter 3 is not supplied to the light emitting diode 7R, but only to the light emitting diodes 7B and 7G. Therefore, the output of the DC/DC converter 3 is decreased to almost two thirds, and the circuit scale of the DC/DC converter 3 can be reduced accordingly. Also, by determining the design condition of the voltage boosting circuit 2+3 in such a manner that the drive capability of the DC/DC converter 3 is higher than the total of the drive capabilities of the two output stage transistors 6B and 6G, and is lower than the total of the drive capabilities of the three output stage transistors 6B, 6G and 6R, the chip size of the IC 10 will become smaller, thus achieving a cost reduction. Also, if the circuit scale is designed identical, it will permit the driving of the light emitting diodes 7B, 7G, and 7R each with a higher current.

Third Embodiment

Now, a concrete configuration of the light emitting device of the portable telephone relating to the third embodiment will be explained with reference to the drawings. FIG. 6 is an overall schematic circuit diagram of the light emitting device relating to this embodiment, which corresponds to FIG. 5 described above.

The difference of the light emitting device of the third embodiment from that of the second embodiment lies in that an automatic control circuit 9 is added, so that the degree of the pulse width to the light emitting diode 7R can be increased or decreased automatically in accordance with the output voltage Vdd of the battery 1.

The automatic control circuit 9 detects the voltage Vdd, for example, with a resistance type potential divider, and based on a detected value E, it calculates the control amount of the duty ratio of the pulse signal. And at the same time, the calculation result is reflected to the threshold given to the PWM circuit 5R from the control unit 8. In this case, since the brightness of the light emitting diode 7R increases as the voltage Vdd rises, the circuit lowers the duty ratio to cancel the increase of the brightness; and since the brightness of the light emitting diode 7R decrease as the voltage Vdd falls, the circuit raises the duty ratio to cancel the decrease of the brightness. Since it is important to maintain the brightness constant, as long as the threshold does not change, the control circuit 9 multiplies the threshold by the inverse number of the detected value E, as illustrated in FIG. 6. Incidentally, since the relation between the voltage Vdd and the brightness of the light emitting diode 7R is generally non-linear, the calculation formula of the control amount should reflect the relation in details for a practical use, and for example, a formula approximated by the polygonal line function may be used.

In this case, the variation of brightness of the light emitting diode 7R caused by the variation of the voltage Vdd is not only eased by a margin higher than the forward voltage, but is positively offset and canceled by the compensation capability of the automatic control circuit 9. Therefore, the state of the light emission is stabilized almost in the same level as the first embodiment. Moreover, the automatic control circuit 9 with small power consumption is suited for a high integration, and the chip size of the IC 10 is almost as small as that of the second embodiment.

Further, in the embodiments described above, the light emitting diode was given as a concrete example of the light emitting element, but the invention can also be applied to one that has the similar property, which is not limited to the diode. Also, as for the light emitting element, the three primary colors blue, green and red are the typical ones. However, it is not limited to these, for example, it may be the combination of two colors only, or the combination of four colors or more.

As it is apparent from the above description, in the light emitting device and the drive IC of the portable telephone as the first measure of the invention, the battery voltage is boosted and stabilized to be supplied to the light emitting elements. Thereby, the light emitting elements are driven with a margin, and they are not affected by or relieved from the variations of the battery voltage, which implements the light emitting device of the portable telephone with stable brightness and color tone.

Also, in the light emitting device and the drive IC of the portable telephone as the second measure of the invention, the boosting capability of the battery voltage is narrowed without losing its driving capability. Thereby, the light emitting device of the portable telephone with stable brightness and color tone can be realized with a smaller scale circuit.

Further, in the light emitting device and the drive IC of the portable telephone as the third measure of the invention, the drive of the light emitting elements is allotted to the voltage boosting circuit and the automatic control circuit of the pulse width modulation. Thereby, the light emitting device of the portable telephone with stable brightness and color tone can be realized with a smaller scale circuit.

What is claimed is:

1. A light emitting device of a portable telephone that operates by a power of a battery together with a communication circuit, comprising:
plural light emitting elements of which light emission colors are different, which are driven individually by a pulse width modulation method, and
a voltage boosting circuit having a smoothing circuit connected to an output side thereof, whose output is supplied to the light emitting elements.

2. A light emitting device of a portable telephone as claimed in claim 1, wherein a part of the light emitting elements is supplied with the output of the battery.

3. A light emitting device of a portable telephone as claimed in claim 2, further comprising an automatic control means that increases and decreases a degree of the pulse width modulation to a part of the light emitting elements in accordance with the output voltage of the battery.

4. A drive IC for a light emitting device comprising:
a voltage boosting circuit having separate terminals connected to an input and output thereof;
plural pulse width modulator circuits, wherein each modulation degree can be set separately; and,
plural drive circuits corresponding to the plural pulse width modulator circuits, wherein a drive state to each connecting terminal is switched in response to an output pulse from a corresponding one of the pulse width modulator circuits.

5. A drive IC for a light emitting device as claimed in claim 4, further comprising an automatic control means that increases and decreases a degree of the pulse width modulation of a part of the pulse width modulator circuits in accordance with an input voltage to the voltage boosting circuit.
